(19) United States
(12) Patent Application Publication
(10) Pub. No.: US 2011/0225980 A1
(43) Pub. Date: Sep. 22, 2011

(54) MAGNETIC FLUX GENERATING DEVICE AND MAGNETIC HEAT PUMP

(75) Inventors: Bruce C.H. CHENG, Taoyuan Hsien (TW); Yu-Yuan TSAI, Taoyuan Hsien (TW); Cheng-Yen SHIH, Taoyuan Hsien (TW)

(73) Assignee: DELTA ELECTRONICS, INC., Taoyuan Hsien (TW)

(21) Appl. No.: 13/053,826

(22) Filed: Mar. 22, 2011

Related U.S. Application Data
(60) Provisional application No. 61/316,252, filed on Mar. 22, 2010.

(51) Int. Cl. F25B 21/00; H01F 38/00; F25D 17/06

(52) U.S. Cl. 62/3.1; 307/104

(57) ABSTRACT

A magnetic flux generating device is provided. The magnetic flux generating device includes: a magnetic flux structure, including: a core and at least one coil wraps around at least part of the core; and a power module, electrically coupled between a power source and the magnetic flux structure, for exciting the magnetic flux structure to generate magnetic flux, the power module including: an energy storage device for storing power outputted from the power source and providing power to the magnetic flux structure. The energy storage device includes at least one super capacitor. A magnetic heat pump based on the magnetic flux generating device is also provided.

### CROSS REFERENCE TO RELATED APPLICATIONS

This Non-provisional application claims priority under 35 U.S.C. §119(a) on Provisional Patent Application No. 61/316,252, filed in United State of America on Mar. 22, 2010, the entire contents of which are hereby incorporated by reference.

### BACKGROUND OF THE INVENTION

1. Field of the Invention

The invention relates to a magnetic flux generating device, and more specifically, to a magnetic flux generating device capable of providing high magnetic flux.

2. Description of the Related Art

Electromagnets are popularly used for generating a magnetic field. The electromagnet is different from the permanent magnet in that the magnetic field of the electromagnet can be eliminated when cutting off the power provided to it.

According to electromagnetic theory and Ampere's law, a magnetic field (measured as quantity of magnetic flux) can be generated by applying currents to a copper wire wrapped around a paramagnetic material made of iron or soft iron, and the magnitude of a magnetic field is related to the number of circles (or the windings) of the copper wire, and quantity of current provided to the copper wire. In prior art, the electromagnet requires more windings and greater currents to generate higher magnetic field.

However, requiring more windings and greater currents means higher cost, poor reliability and less safety. Thus, it is desirable to have a magnetic flux generating device, for example, used in a magnetic heat pump, for generating greater magnetic flux without the previously mentioned deficiencies.

### BRIEF SUMMARY OF THE INVENTION

The present invention provides a magnetic flux generating device, comprising: a magnetic flux structure, comprising: a core and at least one coil wraps around at least a part of the core; and a power module, electrically coupled between a power source and the magnetic flux structure, for exciting the magnetic flux structure to generate magnetic flux, the power module comprising: an energy storage device for storing power outputted from the power source and providing power to the magnetic flux structure.

The present invention also provides a magnetic heat pump, comprising: a magnetic flux structure, comprising: a core; at least one coil, wrapping around at least a part of the core; a power module, electrically coupled between a power source and the magnetic flux structure, for exciting the magnetic flux structure to generate magnetic flux, the power module comprising: an energy storage device, comprising at least one super capacitor, for storing power outputted from the power source and providing power to the magnetic flux structure; and a heat pump module, comprising: a magnetic bed, embedded in at least a part of the core, for generating or absorbing heat through being magnetized or demagnetized by the magnetic flux flowing through the core; and a heat exchange piping loop, coupled among the magnetic bed, a first heat exchanger, and a second heat exchanger, for transferring the heat among the magnetic bed, the first heat exchanger and the second heat exchanger.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram showing the power module of the present invention;

FIG. 2 is a schematic diagram showing the magnetic flux generating device according to the first embodiment of the present invention;

FIG. 3 is a schematic diagram showing the magnetic flux generating device according to the second embodiment of the present invention;

FIG. 4 is a schematic diagram showing the magnetic flux generating device according to the third embodiment of the present invention;

FIG. 5 is a schematic diagram showing the magnetic flux generating device according to the fourth embodiment of the present invention; and

FIG. 6 is a schematic diagram showing a magnetic heat pump according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Power Module

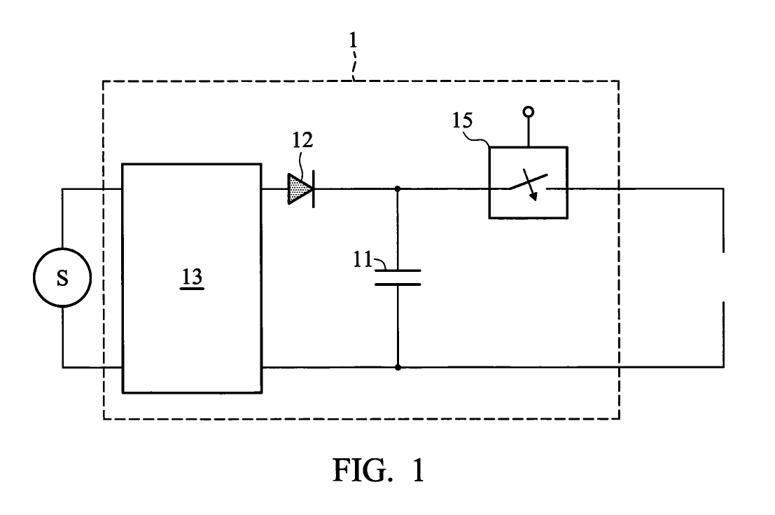

With reference to FIG. 1, a power module of the present invention is shown. The power module 1 is electrically coupled to an outer or external power source S. The power module 1 comprises an energy storage device 11, a power supplying circuit 13, and a switch 15. The power source S is, for example, an AC output, a DC output, a portable battery set, or the like, which outputs power for working to the power module 1. The energy storage device 11, electrically coupled to the power source S, is made of a high volume storage container or media. To absorb power outputted from the power source S with low current in a relative long time period and provide power to the other circuits (not shown in FIG. 1) with high current in a relative much shorter time period, the energy storage device 11 of the present invention comprises at least one super capacitor. The super capacitor here will be further discussed later. The power supplying circuit 13 is electrically coupled between the power source S and the energy storage device 11, and is used to control power inputting and/or outputting from the power source S, charging and/or recharging of the energy storage device 11, and other possible electrical activities that users require. The switch 15, electrically coupled to the energy storage device 11, may be controlled by an external controlling unit (not shown) or an internal control unit, such as the power supplying circuit 13. However, the present invention is not limited to any particular power supplying circuit. Rather, alternative circuit designs are possible, which are known by people having ordinary skills in the art.

The power module 1 is powered by the power source S, and is operated with the power supplying circuit 13. When the power of the power source S is inputted to the power module 1, the energy storage device 11 stores the power outputted from the power source S under control of the power supplying circuit 13. When the power source S is cut off, the energy storage device 11 can be seen as an alternative and new power source. The super capacitor, also known as an electric double-layer capacitor (EDLC), is an element which generally has lower internal resistance and higher energy density than other kinds of known energy storage devices. The super capacitor of the present invention, including lithium ion capacitors (also know as a “hybrid capacitor”), has energy density greater than 136 W·h/kg. This kind of super-capacitor-based energy storage device 11, when recharged, can restore more energy with a smaller current in a relative long time period, and, when discharged, can release more energy with a greater current in a relative much shorter time period. The brilliant charging and discharging performance is an important reason why the super capacitor is appropriate to be used as the energy storage device in the invention. In other embodiments, the energy storage device may be composed of super capacitors, or a combination of the super capacitors and the ordinary capacitors. The switch 15 is an electrical gate between the power module 1 and an external device (not shown in FIG. 1), and is under control of the external controlling unit (not shown in FIG. 1) or the internal controller, such as the power supplying circuit 13. Hence, when the switch 15 is opened, the power module 1 does not power the external device (not shown in FIG. 1) through the switch 15. On the other hand, only when the switch 15 is closed, will the power module 1 power the external device through the switch 15. Thus, the terms “opened” and “closed” will be defined as mentioned through the specification of the invention hereafter. Those skilled in the art can easily control the power outputting from the power module 1 by controlling the external controlling unit or the internal controller, such as the power supplying circuit 13.

The power module 1 can further comprise a diode 12. For example, the diode 12 is electrically coupled between the power supplying circuit 13 and the energy storage device 11. Hence, when the energy storage device 11 is recharged by the power source S under control of the power supplying circuit 13, the diode 12 prevents currents from flowing back from the energy storage device 11 to the power supplying circuit 13. With the diode 12, the process of recharging can be safely finished. Further, when the power source S is cut off, the energy storage device 11 can be seen as an alternative and new power source, and is discharged under control of the switch 15. When the switch 15 is closed, the diode 12 forces the current to flow out to the external device (not shown in FIG. 1). However, the diode 12 is an optional function element, which can be integrated into the power supplying circuit 13.

### Embodiment I of Magnetic Flux Generating Device

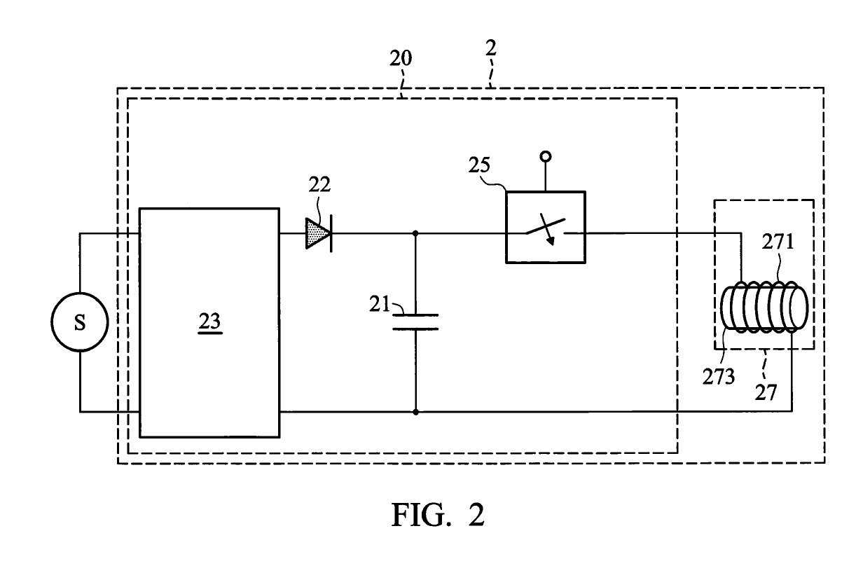

With reference to FIG. 2, a magnetic flux generating device 2 according to an embodiment of the present invention is shown. The magnetic flux generating device 2 comprises a magnetic flux structure and a power module 20 which is electrically coupled between an outer power source S and the magnetic flux structure 27. The power module 20, as the power module 1 of FIG. 1 which we had discussed previously, comprises an energy storage device 21, a power supplying circuit 23, a switch 25, and a diode 22 (optional). The magnetic flux structure 27, as the other circuit or the external device which we had discussed previously, is electrically coupled to the power module 20 and is used to be excited by the power module 20 to generate a magnetic flux. In one embodiment, the magnetic flux structure 27 comprises a coil 271 (or a solenoid). However, in another embodiment, the magnetic flux structure 27 may further comprise a core 273 which is partly wrapped by the coil 271. The core 273 is used for guiding the generated magnetic flux. The core 273, for example, is made of soft iron or magnetic conducting material.

### Embodiment II of Magnetic Flux Generating Device

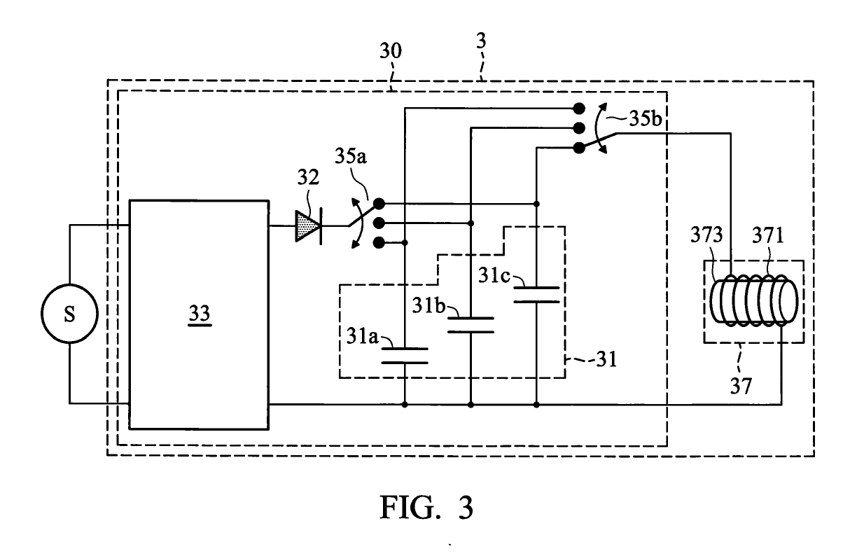

With reference to FIG. 3, a magnetic flux generating device 3 according to another embodiment of the present invention is shown. In this embodiment, the magnetic flux generating device 3 comprises a power module 30 electrically coupled between an outer power source S and a magnetic flux structure 37. The power module 30 comprises a power supplying circuit 33, an energy storage device 31, a first switch 35a, a second switch 35b, and a diode 32 (optional). The magnetic flux structure comprises a core 373 and a coil 371 wrapping around at least a part of the core 373. The second switch 35b makes the magnetic flux generating device 3 of FIG. 3 different from the magnetic flux generating device 2 of FIG. 2. As shown in FIG. 3, the energy storage device 31 of the magnetic flux generating device 3 comprises three super capacitors 31a, 31b and 31c. The three super capacitors 31a, 31b and 31c are electrically coupled between the first switch 35a and the second switch 35b, and may have capacitances different from each other. The first switch 35a is electrically coupled between the super capacitors 31a, 31b and 31c (the energy storage device 31) and the power source S for controlling the electrical connections thereof, while the second switch 35b is electrically coupled between the super capacitors 31a, 31b and 31c (the energy storage device 31) and the coil 371 of the magnetic flux structure 37 for controlling the electrical connections thereof. Therefore, each of the super capacitors 31a, 31b and 31c can be selectively discharged or charged, and can output power to the magnetic flux structure 37. Hence, the magnetic flux structure 37 can selectively generate magnetic flux of different magnitudes. Further more, the power supplying circuit 33 can be used more efficiently in this configuration, while one of the super capacitors is in discharging status and the power supplying circuit 33 can charge another super capacitor with idling.

### Embodiment III of Magnetic Flux Generating Device

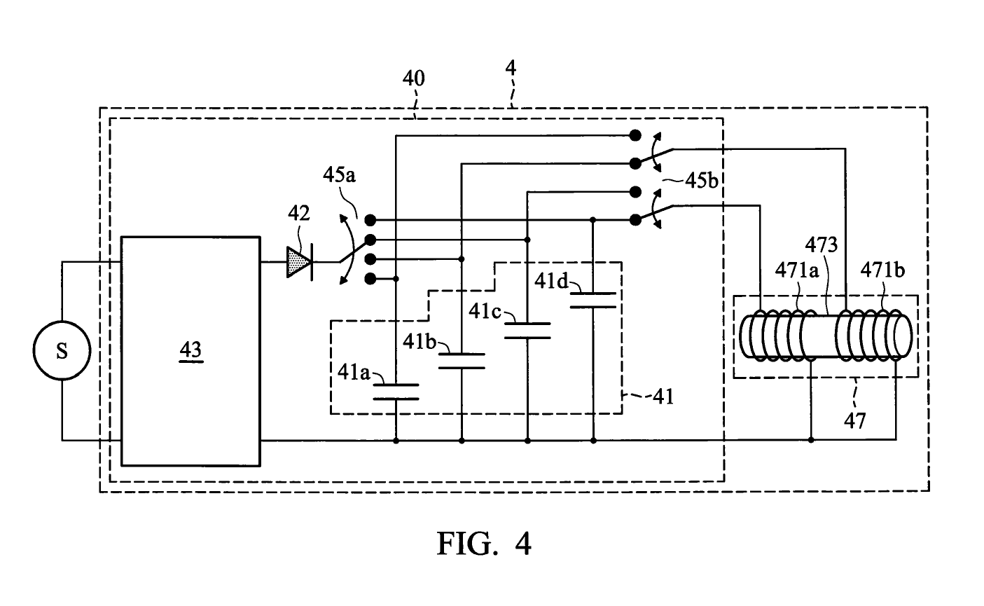

With reference to FIG. 4, a magnetic flux generating device 4 according to still another embodiment of the present invention is shown. In general, when comparing the magnetic flux generating device 4 of FIG. 4 and the magnetic flux generating device 3 of FIG. 3 as we had mentioned, they are different in the number of second switches the coils to be used. The magnetic flux generating device 4 comprises a power module 40 electrically coupled between an outer power source S and a magnetic flux structure 47. The power module 40 comprises an energy storage device 41, a power supplying circuit 43, a first switch 45a, a plurality of second switches 45b, and a diode 42 (optional). The energy storage device 41 comprises, for example, four super capacitors 41a, 41b, 41c and 41d. The magnetic flux structure 47 comprises, for example, a core 473, a first coil 471a and a second coil 471b, the coils 471a and 471b are electrically coupled to the second switches 45b. In this embodiment, the first coil 471a and the second coil 471b, wrapping around part of the core 473, are arranged in series, thus the magnetic flux structure 47 may generate two different magnetic flux along a same line and toward a same direction through the core 473. Note that the arrangement, the outer length, and the winding style of the first coil 471a and the second coil 471b are all design choices and can be determined by users. In other embodiments (not shown in FIGS), two coils of the magnetic flux structure may be arranged in two parallel lines, and so that the two coils generate magnetic flux along two different lines and toward a same direction or an opposite directions.

### Embodiment IV of Magnetic Flux Generating Device

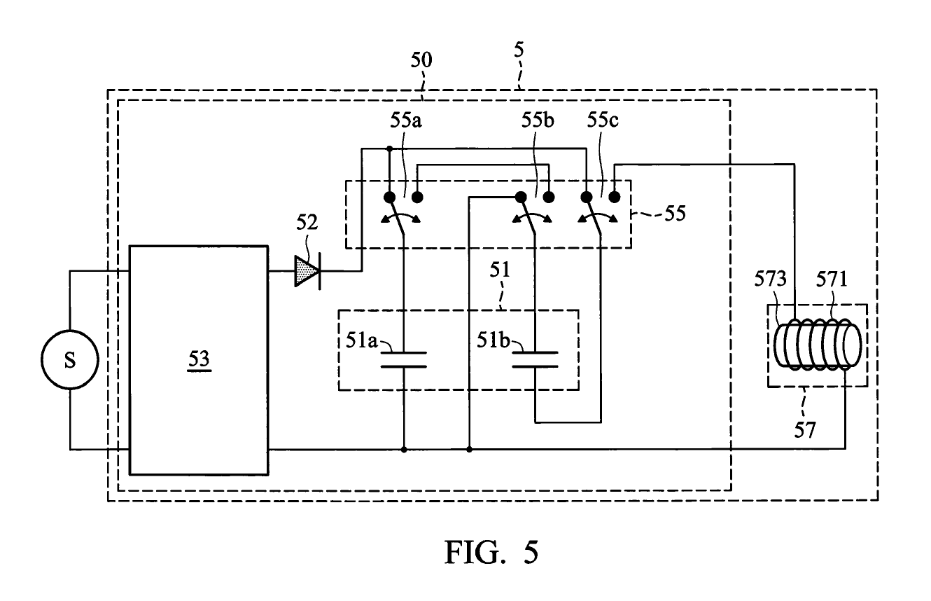

Referring to FIG. 5, a magnetic flux generating device 5 according to yet another embodiment of the present invention is shown. In general, the magnetic flux generating device 5 of FIG. 5 is different from the magnetic flux generating device 2 of FIG. 2, there are multiple switches shown in FIG. 5, instead of a single switch shown in FIG. 2. The magnetic flux generating device 5 comprises a power module 50 electrically coupled between an outer power source S and the magnetic flux structure 57. The power module 50, in this embodiment, comprises an energy storage device 51, a power supplying circuit 53, a plurality of switches 55a, 55b and 55c, and a diode 52 (optional). In this embodiment, the energy storage device 51 comprises two super capacitors 51a and 51b, the super capacitors 51a and 51b may be electrically connected in series due to selectively opening or closing the switches 55a, 55b and 55c. The magnetic flux structure 57 comprises a core 573 and a coil 571 wrapping around at least a part of the core 573, wherein the coil 573 is electrically coupled to the set of switches 55. The switches 55a, 55b, 55c can be selectively closed or opened as mentioned, and thus the super capacitors 51a and 51b can be coupled in series or in parallel and the magnetic flux generating device 5 can be operated in various voltage or current conditions. For example, when the super capacitors 51a and 51b are all coupled in series, the magnetic flux structure 57 will have the greatest magnetic flux.

### Embodiment of Magnetic Heat Pump

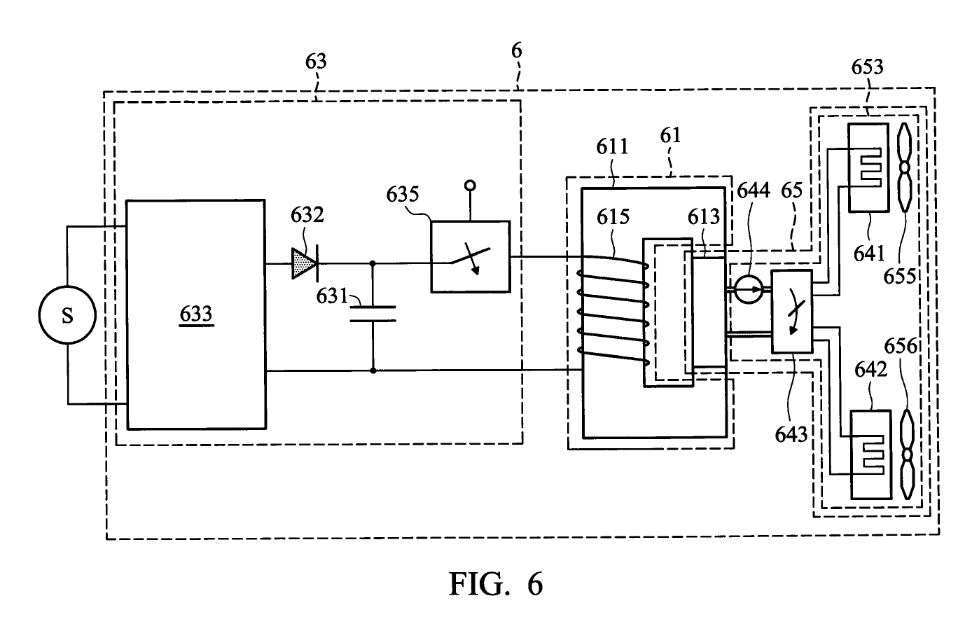

Referring to FIG. 6, a magnetic heat pump 6 according to an embodiment of the present invention is shown. The magnetic heat pump 6 comprises a magnetic flux structure 61, a power module 63, and a heat pump module 65. The magnetic flux structure 61 comprises a core 611 and a coil 615 wrapping around at least a part of the core 611. In this embodiment, the core 611 is a square C shaped core, but in other embodiments, is not limited thereto. The core 611 is made of, for example, magnetic conductive material. The power module 63 is coupled between an outer power source S and the magnetic flux structure 61, as described previously. The power module 63 comprises an energy storage device 631, a power supplying circuit 633, a switch 635, and a diode 632 (optional). The power module 63 is used to excite the magnetic flux structure 61 to generate magnetic flux. The heat pump module 65 is coupled to the magnetic flux structure 61, and comprises a magnetic bed 613, and a heat exchange piping loop 653. The magnetic bed 613, for example, is embedded in a gap of the core 611 and composed of magneto-caloric material (MCM) in order to provide a closed magnetic path for magnetic flux generated by the magnetic flux structure 61, wherein the closed magnetic path is formed in the magnetic flux structure 61 and the magnetic bed 613. In the present invention, the magneto-caloric material is selected from the group consisting of FeRh, Gd₅Si₂Ge₂, RCo₂, La(Fe,Si)₁₃, MnAs₁₋ₓSbₓ, MnFe(P, As), Co(S₁₋ₓSex)₂, NiMnSn, or MnCoGeB. The magnetic flux generated by the magnetic flux structure 61 can flow through the closed path as mentioned, that is, from internal part of the core 611 to the magnetic bed 613 of the heat pump module 65 and finally back to internal part of the core 611, thus magnetizing the magnetic bed 613. On the other hand, once the magnetic flux structure 61 is not excited by the power module 63 so that the magnetic flux is not generated, the magnetic bed 613 is demagnetized. In brief, the magnetic bed 613 can be selectively magnetized or demagnetized and thus generate or absorb heat (surrounding environment is therefore heated or cooled) due to the magnetic entropy change. The heat exchange piping loop 653 is coupled between the magnetic bed 613, at least two heat exchangers 641 and 641). In one embodiment, the heat exchange piping loop 653 contains heat conducting fluid, which flows through the heat exchange piping loop 653, to enhance the heat exchange of the magnetic heat pump 6. The heat exchange piping loop 653 may further comprise a fluid pump 644 for pumping the heat conducting fluid and a flow route controller 643 for controlling the route in which the heat conducting fluid flows through the heat exchange piping loop 653. In this embodiment, the flow route controller 643 may control the heat conducting fluid flows to the low temperature side heat exchanger 641 or the high temperature side heat exchanger 642, i.e., the low temperature side heat exchanger 641 (the cold side) may reduces to lower temperature, and the high temperature side heat exchanger 642 (the hot side) may raises to the higher temperature after finishing a few times of flow change. Therefore, heat is generated or absorbed by the magnetic bed 613 and transferred heat between two heat exchangers 641 and 642 through the heat exchange piping loop 653. In this embodiment, the magnetic flux structure 61 and the power module 63 constitute the magnetic flux generating device of the embodiment I. However, in other embodiments, the magnetic flux generating device can be replaced by any magnetic flux generating devices shown in FIGS as we had described. Due to the work of the magnetic flux generating device, the magnetic heat pump 6 of the present invention can pump heat produced therein. In a better embodiment of the present invention, the heat pump module 65 may further comprise a first fan 655, which is disposed around the low temperature side heat exchanger 641, so the heat exchanger 641 can absorb the heat from surround environment with airflow. In another embodiment, the heat pump module 65 may further comprise a second fan 656, which is disposed around the high temperature side heat exchanger 642 for removing the heat from low temperature side heat exchanger 642 with airflow. Note that person with skill in the art will recognize this alternative arrangement for the two heat exchangers, and the arrangement will not be limitations to the present invention.

In summary, the invention provides a magnetic flux generating device and a magnetic heat pump using the magnetic flux generating device. Due to the super capacitors in the power module, the magnetic flux generating device of the present invention can produce greater magnetic flux with greater power than those of prior art. The high performance of the power module of the present invention is attributed to the high energy density of the super capacitors. The magnetic flux generating device can be applied in any apparatus using magnetic energy, for example, a magnetic heat pump for being a radiator and/or refrigerator, an electromagnetic lock and the like. When the magnetic flux generating device is used in the magnetic heat pump, the magnetic heat pump can reach higher heating or cooling efficiency owing to the greater magnetic flux generated by the magnetic flux generating device. When the magnetic flux generating device is used in the electromagnetic lock, the electromagnetic lock can push a larger latch or a more complex locking mechanism than conventional electromagnetic lock due to suddenly high power outputting of the super capacitor.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A magnetic flux generating device, comprising:
a magnetic flux structure, comprising:
a core;
at least one coil wraps around at least a part of the core; and
a power module, electrically coupled between a power source and the magnetic flux structure, for exciting the magnetic flux structure to generate magnetic flux, the power module comprising:
an energy storage device for storing power outputted from the power source and providing power to the magnetic flux structure.

2. The magnetic flux generating device as claimed in claim 1, wherein the energy storage device comprises at least one super capacitor, each of the super capacitor has an energy density greater than 136 W·h/kg.

3. The magnetic flux generating device as claimed in claim 1, wherein the power module comprises at least one first switch for controlling the electrical connections between the energy storage device and the power source.

4. The magnetic flux generating device as claimed in claim 1, wherein the power module comprises at least one second switch for controlling the electrical connections between the energy storage device and the magnetic flux structure.

5. The magnetic flux generating device as claimed in claim 2, wherein the power module comprises at least one third switch for controlling the electrical connections among the at least one super capacitor.

6. The magnetic flux generating device as claimed in claim 1, wherein the at least one coil is arranged in series or in parallel.

7. The magnetic flux generating device as claimed in claim 1, wherein the power module further comprises:
a power supplying circuit, coupled between the power source and the energy storage device, for controlling the charging and discharging of the energy storage device.

8. The magnetic flux generating device as claimed in claim 1, wherein the core is composed of magnetic conductive material.

9. A magnetic heat pump, comprising:
a magnetic flux structure, comprising:
a core;
at least one coil, wrapping around at least a part of the core;
a power module, electrically coupled between a power source and the magnetic flux structure, for exciting the magnetic flux structure to generate magnetic flux, the power module comprising:
an energy storage device, comprising at least one super capacitor, for storing power outputted from the power source and providing power to the magnetic flux structure; and
a heat pump module, comprising:
a magnetic bed, embedded in at least a part of the core, for generating or absorbing heat through being magnetized or demagnetized by the magnetic flux flowing through the core; and
a heat exchange piping loop, coupled among the magnetic bed, a first heat exchanger, and a second heat exchanger, for transferring the heat among the magnetic bed, a first heat exchanger and a second heat exchanger.

10. The magnetic heat pump as claimed in claim 9, wherein the core is composed of magnetic conductive material.

11. The magnetic heat pump as claimed in claim 9, wherein the magnetic bed is composed of magneto-caloric material.

12. The magnetic heat pump as claimed in claim 11, wherein the magneto-caloric material is selected from the group consisting of FeRh, Gd₅Si₂Ge₂, RCo₂, La(Fe,Si)₁₃, MnAs₁₋ₓSbₓ, MnFe(P, As), Co(S₁₋ₓSex)₂, NiMnSn, or MnCoGeB.

13. The magnetic heat pump as claimed in claim 9, wherein the heat exchange piping loop contains heat conducting fluid flowing therethrough.

14. The magnetic heat pump as claimed in claim 9, wherein the heat exchange piping loop further comprises a flow route controller.

15. The magnetic heat pump as claimed in claim 9, wherein the heat exchange piping loop further comprises a fluid pump.

16. The magnetic heat pump as claimed in claim 9, wherein the heat exchange piping loop further comprises a first fan disposed around a first heat exchanger.

17. The magnetic heat pump as claimed in claim 9, wherein the heat exchange piping loop further comprises a second fan disposed around a second heat exchanger.
